(19) United States
(12) Patent Application Publication
(10) Pub. No.: US 2010/0178938 A1
(43) Pub. Date: Jul. 15, 2010

(54) SYSTEMS AND METHODS FOR CUSTOMIZING RADIO PRESETS

(75) Inventors: Michael I. Ingrassia, JR., San Jose, CA (US); Jeffery Lee, Sunnyvale, CA (US); Allen P. Haughay, JR., San Jose, CA (US)

Correspondence Address: KRAMER LEVIN NAFTALIS & FRANKEL LLP, 1177 Avenue of the Americas, New York, NY, 10036, US

(73) Assignee: APPLE INC., Cupertino, CA (US)

(21) Appl. No.: 12/353,051

(22) Filed: Jan. 13, 2009

(51) Int. Cl. H04W 24/00; H04B 1/18

(52) U.S. Cl. 455/456.3; 455/185.1

(57) ABSTRACT

Systems and methods are provided for customizing radio presets. The radio presets can be customized based on one or more of geographic location and user preferences. For example, radio presets bookmarking particular radio frequencies can be associated with a particular location. When a user device is in the particular location, the associated radio frequencies can be used to populate “hot keys.” In some embodiments, if radio presets are not available for a particular location, recommended radio presets can be determined by, for example, comparing radio station information with user preferences. This radio station information can include, for example, a listing of available radio stations, the genre of these radio stations, and radio station names. User preferences can include, for example, preferred songs, preferred radio stations, preferred radio shows, and preferred genres. Recommended radio presets can be determined by identifying available radio stations that match the user preferences.

### FIELD OF THE INVENTION

This relates to systems and methods for customizing radio presets. In particular, this relates to systems and methods for customizing radio presets based on one or more of geographic location and user preferences.

### BACKGROUND OF THE INVENTION

Radio systems are used in a variety of devices and locations. For example, radio systems can be integrated in a handheld or portable device or can be installed in a motor vehicle. Thus, the radio system may readily move from one location to another. As the radio system moves from one location to another location, the selection of radio stations that can be received can change.

Additionally, a user may have particular radio stations or genres of radio stations which interest him, or the user may have “preset” particular radio stations. As used here, “radio presets” refer to one or more radio frequencies that have been saved or bookmarked. For example, a radio preset may include a hot key that bookmarks a particular radio frequency. When the hot key is selected, a tuner can tune to that particular frequency. However, as a user moves from one location to another location, the availability of radio stations and the particular broadcast frequencies of known radio stations can change. Thus, when traveling to a new location, the user may not immediately know at which frequency his preferred radio stations are broadcast. Additionally, in the new location, the radio frequency that a radio preset bookmarks may receive a different radio station.

### SUMMARY OF THE INVENTION

Systems and methods are provided for customizing radio presets. In some embodiments, the radio presets can be customized based on one or more of geographic location and user preferences.

In some embodiments, the current geographic location can be identified by determining an area fingerprint of radio broadcasts. Generally, the area fingerprint can be a set of data points relating to available radio station frequencies and their associated signal strengths in that particular area. In other embodiments, the current geographic location can be determined through ways such as, for example, a GPS system, a cellular network, a location-providing service, or a user-entered input.

Radio presets can be defined based on the current geographic location. For example, a user may define radio presets for a first location that associates a first set of radio frequencies with that first location, and radio presets for a second location that associates a second set of radio frequencies with the second location. When situated in the first location, the user device can populate a set of “hot keys” with bookmarks for the first set of radio stations. However, if the user device moves to the second location, the hot key associations can be redefined (automatically or in response to a user instruction) to bookmark the second set of radio stations.

In some embodiments, the user device can determine a recommended set of radio presets by comparing radio station information for the current location with user preferences. Radio station information can include, for example, a listing of the available radio stations within that location, genres associated with the available radio stations, the names of the available radio stations, the song playing on each available radio station and information associated with the song (e.g., artist name or album name), the radio shows that are available on each available radio station, or any other suitable information related to available radio stations in the current geographic location.

User preferences can include interests such as, for example, preferred genres, preferred artists, preferred composers, preferred albums, preferred songs, preferred radio stations, preferred radio shows, or any other information related to a user's interests. User preferences can be manually entered by a user, automatically determined by the user device, or both. The recommended radio presets can then be defined based on available radio stations which match the user preferences.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIG. 1 shows an illustrative user device in accordance with some embodiments of the present invention;

FIG. 2 shows a schematic view of an illustrative user device in accordance with some embodiments of the present invention;

FIG. 3 shows an illustrative user interface for defining radio presets;

FIG. 4 shows an illustrative block diagram of a communication system in accordance with some embodiments of the present invention; and

FIG. 5 shows an illustrative flow chart for customizing radio presets in accordance with some embodiments of the present invention.

### DETAILED DESCRIPTION OF THE INVENTION

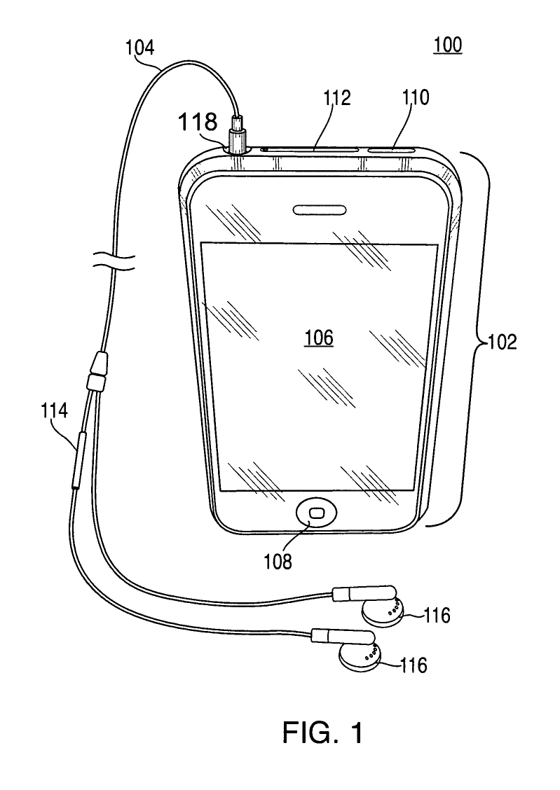

FIG. 1 shows illustrative user device 100 that is in accordance with some embodiments of the present invention. User device 100 may generally be any device that can receive radio stations. For example, in some embodiments, user device 100 can internally have a radio tuner. In other embodiments, user device 100 can have the necessary ports to be coupled to an external radio tuner. User device 100 can then receive radio signals through the external radio tuner. For example, user device 100 can be a handheld radio, a car radio, a cellular phone, a personal data assistant (PDA), a handheld digital music player such as an iPod™ (available from Apple Inc. of Cupertino, Calif.), or a laptop computer. Although user device 100 is generally depicted as a handheld device in FIG. 1, user device 100 can also be a non-handheld device such as a desktop computer.

User device 100 can include main device 102 and one or more accessory devices 104. Generally, any of the components of user device 100 described below can be integrated into main device 102, contained in accessory device 104, or both. For example, as discussed above, a radio tuner can be integrated into accessory device 104 or integrated directly inside main device 102. Additionally, although accessory device 104 is depicted as being physically coupled to main device 102 in FIG. 1, accessory device 104 may alternatively be wirelessly coupled to main device 102.

In some embodiments, user device 100 can include display screen 106. Further to the discussion above, display screen 106 does not need to be integrated into main device 102, and in other embodiments can be an accessory device that is physically or wirelessly coupled to main device 102. Display screen 106 can include any suitable screen, such as a television screen, a computer monitor, a projection screen, a liquid crystal display (LCD) screen, or an organic light-emitting diode (OLED) screen. Display screen 106 can present various types of information to the user such as graphical and/or textual displays. This can include, for example, user-selectable options, radio station playlists, music playlists, stored videos, stored photos, stored data, and system information. In some embodiments, display screen 106 can function as a user input mechanism that allows for a touch screen or user input via a stylus.

User device 100 can also include one or more of user input mechanisms 108 and 110. These mechanisms can be, for example, a keyboard, buttons, switches, track wheels, or click wheels. User device 100 can include one or more of port 112 for coupling external data and/or hard drives into user device 100. For example, port 112 can enable user device 100 to receive SIM cards, flash drives, or external hard drives. There can be multiple ways of connecting accessories devices through, for example, connector 114. Persons skilled in the art will appreciate that connector 114 can be any suitable connector such as one or more USB ports, 30-pin connector ports, dock or expansion ports, and headset jacks.

User device 100 can also include user input/output devices such as microphone 114 and speakers 116. Although depicted as being contained in accessory device 104, one skilled in the art would appreciate that microphone 114 and speakers 116 may alternatively or additionally be contained in main device 102.

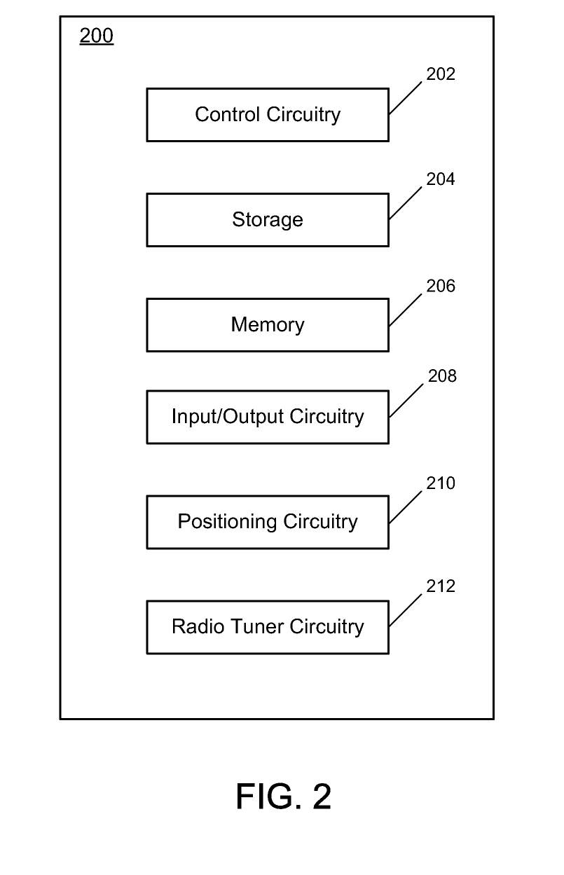

FIG. 2 shows a schematic view of an illustrative user device in accordance with some embodiments of the invention. For example, user device 200 can correspond to user device 100 of FIG. 1. User device 200 can include control circuitry 202, storage 204, memory 206, input/output circuitry 208, positioning circuitry 210, and radio tuner circuitry 212. In some embodiments, one or more of user device components 200 can be combined or omitted (e.g., combine storage 204 and memory 206). In some embodiments, user device 200 can include other components not combined or included in those shown in FIG. 2 (e.g., motion detection components, a power supply such as a battery, or a bus), or several instances of the components shown in FIG. 2. For the sake of simplicity, only one of each of the components is shown in FIG. 2.

Control circuitry 202 can include any processing circuitry or processor operative to control the operations and performance of user device 200. For example, control circuitry 200 can be used to run operating system applications, firmware applications, media playback applications, radio tuner applications, or any other application. In some embodiments, the control circuitry can drive a display and process inputs received from a user interface.

Storage 204 can include, for example, one or more storage mediums including a hard-drive, solid state drive, flash memory, permanent memory such as ROM, any other suitable type of storage component, or any combination thereof. Storage 204 can store, for example, media data (e.g., music and video files), application data (e.g., for implementing functions on device 200), firmware, user preference information data (e.g., radio preset preferences), authentication information (e.g. libraries of data associated with authorized users), wireless connection information data (e.g., information that can enable user device 200 to establish a wireless connection), and any other suitable data or any combination thereof.

Memory 206 can include cache memory, semi-permanent memory such as RAM, and/or one or more different types of memory used for temporarily storing data. In some embodiments, memory 206 can also be used for storing data used to operate user device applications, or any other type of data that can be stored in storage 204. In some embodiments, memory 206 and storage 204 can be combined as a single storage medium.

Input/output circuitry 208 can be operative to convert (and encode/decode, if necessary) analog signals and other signals into digital data. In some embodiments, input/output circuitry 208 can also convert digital data into any other type of signal, and vice-versa. Although input/output circuitry 208 is illustrated in FIG. 2 as a single component of user device 200, several instances of input/output circuitry can be included in user device 200.

Positioning circuitry 210 can include any suitable circuitry for determining the current position of user device 200. In some embodiments, positioning circuitry 210 can include a global positioning system (“GPS”) receiver for accessing a GPS application function call that returns the geographic coordinates (i.e., the geographic location) of user device 200. The geographic coordinates can be fundamentally, alternatively, or additionally derived from any suitable trilateration or triangulation technique. For example, the device can determine its location using various measurements (e.g., signal-to-noise ratio (“SNR”) or signal strength) of a network signal (e.g., a cellular telephone network signal) associated with the device. Other forms of wireless-assisted GPS (sometimes referred to herein as enhanced GPS or A-GPS) can also be used to determine the current position of user device 200. In some embodiments, a device can determine its location based on a wireless network or access point that is in range or a wireless network or access point to which the device is currently connected.

In some embodiments, positioning circuitry 210 can determine the location of user device 200 from an area fingerprint. An area fingerprint can be defined by a set of data points relating to available radio station frequencies and their associated signal strengths in a particular area (e.g., detected using radio tuner circuitry 212, discussed in more detail below). Generally, the area fingerprint may be uniquely associated with a particular location. To determine an area fingerprint, positioning circuitry 210 can scan or direct radio tuner circuitry 212 to scan a portion of or the entire local radio-frequency (RF) spectrum and determine the signal strengths associated with the various frequencies of the RF spectrum. Once the area fingerprint has been determined, the device can retrieve the current geographic location associated with the determined area fingerprint. If the determined area fingerprint is new, the user device can define a new geographic location in a database of area fingerprints to associate with the new area fingerprint.

The user device can identify available radio stations by performing a devoted scan of the RF spectrum. Alternatively, to avoid monopolizing the user of the radio tuner, an area fingerprint can be determined in the background as a user chooses various radio stations. For example, each time the user chooses a new radio station, the associated signal strength can be determined and added as another data point to the area fingerprint. Once a sufficient number of data have been collected for that area fingerprint, the geographic location can be identified. Since scanning can occur in the background as a user listen to the radio, this approach may be a less intrusive and less time-consuming way of determining an area fingerprint.

In some embodiments, a user can control the manner in which data points detected by a background scan are used to define an area fingerprint. For example, the user may adjust when a background scan starts or the time period in which data points may be collected. As another example, if the user knows that he does not travel often, he may allow all data points within the last month to be used in determining an area fingerprint. However, if the user knows that he does travels often, he may only allow data points collected within the past hour to be used in determining the area fingerprint (e.g., since data points collected from more than an hour ago may have been collected in a different location than the current location).

Radio tuner circuitry 212 can include any suitable circuitry for tuning to a particular frequency of a received radio signal. For example, by resonating at a particular frequency, radio tuner circuitry 212 can pass that particular frequency and exclude any other frequencies that were received with the radio signal. Radio tuner circuitry can communicate with input/output circuitry 208 to audibly output the particular frequency through, for example, speakers 116 of FIG. 1.

In some embodiments, user device 200 can include a bus operative to provide a data transfer path for transferring data to, from, or between control processor 202, storage 204, memory 206, input/output circuitry 208, positioning circuitry 210, radio tuner circuitry 212, and any other component included in the user device.

As mentioned above, the user device (e.g., user device 100 of FIG. 1 or user device 200 of FIG. 2) can tune radio waves associated with radio stations. However, the specific radio stations that the user device can tune may change based on the geographic location of the user device. In particular, for a given frequency, the user device can typically receive the transmission from a radio station having the most powerful broadcast at that given frequency. For example, in San Francisco, Radio Station ABC may be broadcast and received on 100.3 MHz. However, in New York City, the signal for Radio Station ABC may be too weak to be received by the user device. Instead, in New York City, Radio Station XYZ may be broadcast and received on 100.3 MHz. Radio Station ABC may either be broadcast at an alternate frequency (e.g., from a different radio tower) in New York City than in San Francisco, or in some instances may not even be available in New York City.

Accordingly, if a user is listening to the radio through the user device and moves from one location to another, the selection of available radio stations can change with the device location. In addition, because of the variation in available radio stations, a user may be unaware of what radio stations are obtainable in a particular location. For example, the user may not know whether Radio Station ABC is available in the new location or at what frequency it is broadcast.

If a user has set radio presets for a particular location, when the user moves the presets may no longer be adapted. In particular, if a user selects a hot key bookmarking a particular frequency associated with a radio station broadcast in a particular location, the user device may not tune to the appropriate radio station when the user is outside of a determined geographic location. The hot keys can include a selectable option such as, for example, a physical button on the user device or a user-selectable option on a graphical user interface (“GUI”).

Accordingly, it may be beneficial for the user device to define radio presets based on a geographic location. For example, in one geographic location, a set of hot keys may bookmark a particular set of frequencies. However, in a different geographic location, the hot keys can be redefined by the user device to bookmark a different set of frequencies. Various ways of defining radio presets will be discussed in greater detail in the discussions to follow.

In some embodiments, the device can determine the current location to allow the device to identify the appropriate location-specific radio presets. For example, as described in more detail above with reference to positioning circuitry 210 of FIG. 2, the user device can determine the current location through a GPS system, a cellular network, a location-providing service, or an area fingerprint based on radio frequencies and their associated signal strengths. In other embodiments, the user may manually enter the current location. For example, the user may enter the city and state or the zip code of the current location.

Once the current location has been determined (e.g., by any of the above-mentioned techniques), the radio presets for the current location can be identified. In some embodiments, a user can pre-define radio presets that are associated with one or more locations. For example, a radio preset for the geographic location, New York City, can include a preferred set of radio stations broadcast in New York City. This “New York City” radio preset may utilize hot keys to bookmark the set of radio stations. Additionally, a second radio preset for the geographic location, Albany, can include a second set of preferred radio stations that are broadcast in Albany. Similarly, this “Albany” radio preset may utilize hot keys to bookmark the Albany preferred radio stations. If the current location of the user device is determined to be New York City, the radio presets for New York City can be identified and the hot keys can be defined to bookmark the New York City preferred radio stations. If, however, the user device moves to Albany, the radio presets for Albany can be identified, and the hot keys can be automatically redefined to bookmark the Albany preferred radio stations.

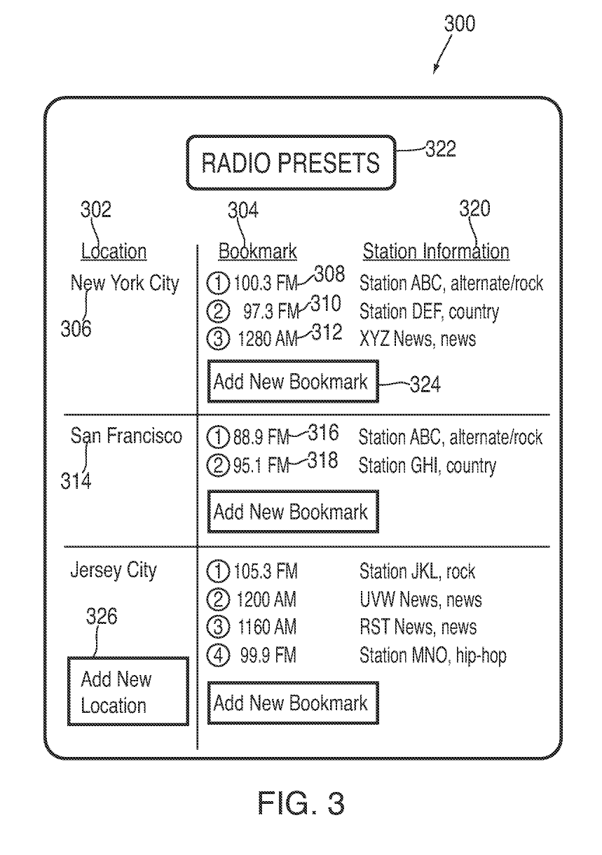

Radio presets can be defined through any suitable method. For example, while the user device is tuned to a particular frequency, a user may press and hold a hot key for a predetermined amount of time (e.g., for 3 seconds) to bookmark that particular frequency with the hot key for the current location. As another example, the user device or a host device coupled to the user device may include a display (e.g., display screen 106 of FIG. 1) with a user interface that can be used to define radio presets. For example, FIG. 3 shows illustrative user interface 300 that can be used to define radio presets (e.g., identified by title 322). User interface 300 can include one or more locations and their associated bookmarks. For example, Location Column 302 can include one or more geographic locations. Each geographic location in Location Column 302 can be associated with one or more frequencies, such as one or more of the frequencies listed in Bookmark Column 304. For example, location 306 can be associated with frequency 308, frequency 310, and frequency 312. Similarly, location 314 can be associated with frequency 316 and frequency 318. Accordingly, if a user device determines that the current location is New York City (location 306), the hot keys can be populated with bookmarks for 100.3 FM, 97.3 FM, and 1280 AM (frequencies 308, 310, and 312). If the user device changes location from New York City to San Francisco (location 314), the hot keys can be changed to bookmark 88.9 FM and 95.1 FM (frequencies 316 and 318).

In some embodiments, user interface 300 can include Information Column 320. Information Column 320 may list information associated with the radio stations of the frequencies in Bookmark Column 304 such as, for example, radio station name, radio station genre, or any other suitable descriptive information.

User interface 300 can have New Bookmark Option 324. New Bookmark Option 324 can be a user-selectable option to allow a user to bookmark a frequency associated with a particular location. For example, a user can select New Bookmark Option 324 and then input a particular frequency (e.g., through user input mechanisms 108 or 110 of FIG. 1) to associate that frequency with location 306. User interface 300 can have New Location Option 326. New Location Option 326 can be a user-selectable option to allow a user to add a new location for the radio presets. For example, when defining radio presets, a user may add a new location through New Location Option 326 (e.g., by providing a zip code, city name, or GPS coordinates) and then associate one or more frequencies with that new location.

In some embodiments, rather than manually defining the location for radio presets (e.g., through New Location Option 326), a user device can automatically define the location. For example, when receiving a request to bookmark a particular frequency, the user device can determine the current location. This particular frequency can then be automatically associated with the current location. For example, if a user requests to bookmark 97.3 FM while in San Jose, the user device can determine that the current location is San Jose (e.g., through a GPS, through a cellular network, or through an area fingerprint). The user device can then bookmark 97.3 FM and associate this bookmark with the geographic location, San Jose. Then, whenever the user device is in San Jose, the hot keys can be redefined to reference the frequency, 97.3 FM.

In some embodiments, the radio presets can be updated to reflect the radio stations that have a stronger detected signal. For example, a particular radio station may be broadcast on two different frequencies in the same location (e.g., Radio Station ABC may be broadcast at both 98.5 FM and 102.4 FM). The signal strength of each frequency can then be determined, and the frequency with the stronger signal strength can be bookmarked (e.g., bookmarked to a particular hot key).

In some embodiments, a user device can determine recommended radio presets. For example, a user device may enter a geographic location for which no radio frequencies are bookmarked. The user device can then automatically identify one or more recommended radio stations and save the frequencies for those radio stations as presets (e.g., bookmark their associated frequencies with hot keys). In some embodiments, to identify recommended radio stations, radio station information can be determined and then compared to user preferences, radio presets for other locations, or both. The radio station information may be, for example, a listing of one or more of the available radio stations for the area, the genre of each available radio station, and the radio shows or songs played on each of the available radio stations, or any other suitable information.

To determine recommended radio presets, in some embodiments the radio station information for the current area can be compared to user preferences. User preferences can be entered by a user, automatically determined by the user device, or both. User preferences can include interests such as, for example, preferred genres, preferred artists, preferred composers, preferred albums, preferred songs, preferred radio stations, preferred radio shows, or any other suitable information related to a user's interests. Thus, as one example, if a user preference defines that a user like the genre “Rock music,” the radio station information can be searched to identify which frequencies in the current location broadcast radio stations playing Rock music. The identified frequencies can then be bookmarked (e.g., by setting a hot key to bookmark that frequency). As another example, the user preference can indicate that a user prefers certain radio stations or certain radio shows (e.g., “The Morning Show with Bob and Julie”). The radio station information can be searched to determine if that particular radio station or radio show is available in the current area. If the particular radio station or radio show is available, the associated radio frequency can be bookmarked.

In some embodiments, rather than a user explicitly entering user preferences (e.g., preferred genres, preferred artists, preferred composers, preferred albums, preferred songs, preferred radio stations, or preferred radio shows), the user device can automatically determine user preferences. For example, by monitoring radio stations to which a user listens, the user device can intelligently determine genres, stations, artists, albums, songs, and shows the user may prefer. In some embodiments, in addition to or instead of monitoring radio stations, the user preferences can be intelligently determined by monitoring a user's playback history of local media. For example, the user device may store songs or shows in a storage device, such as storage 204 of FIG. 2. The user device may then monitor the user's selection and playback of the stored shows and songs to intelligently determine the user preferences. The radio presets can then be updated to include recommended radio stations matching the intelligently determined user preferences.

Alternatively or additionally, rather than comparing radio station information to user preferences, the radio station information can be compared to radio presets for other locations. For example, there can be alternate radio presets for particular radio stations, particular genres, or particular shows that are associated with other locations. These alternate radio presets can be compared to the radio station information for the current location to determine whether there are any radio stations matching the alternate radio presets. For example, if a radio preset for another location bookmarks Radio Station ABC, the radio station information for the current location can be checked to determine whether Radio Station ABC is available in the current location. If Radio Station ABC is available, this radio station can be bookmarked as a recommended radio preset.

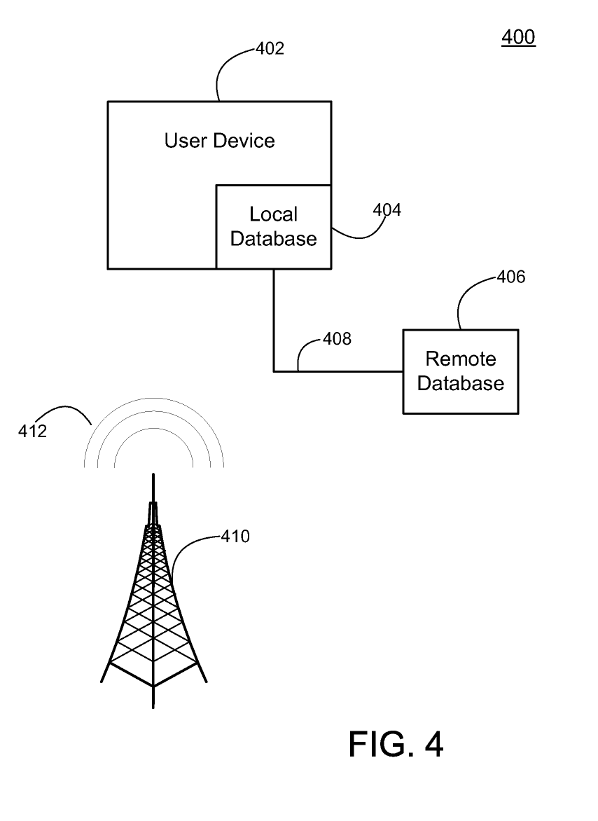

In some embodiments, the radio station information, radio presets, or both can be stored in a local database in the user device. For example, FIG. 4 shows system 400 with user device 402 and local database 404. User device 402 may, for example, correspond to user device 100 of FIG. 1. Local database 404 may store radio station information, radio presets, or both for all available geographic locations or for a portion of the available geographic locations. For example, by only storing radio station information or radio presets for geographic locations which the user device is likely to enter, local database 404 can require a smaller amount of storage space than if information for all available geographic locations were stored. Once the current geographic location has been determined, the radio station information or radio presets for that particular geographic location can be accessed from local database 404.

In some embodiments, local database 404 can be coupled to remote database 406 through link 408. Local database 404 may update the locally stored radio station information, radio presets, or both with data from remote database 406. Link 408 may include, for example, a wired connection or a wireless connection between the two databases (e.g., a cellular network connection, WiFi connection, infrared connection, internet connection, connection through a cable such as a USB cable, or a serial cable).

Local database 404 may access remote database 406 to update its radio station information, radio presets, or both when, for example, a new geographic location has been entered, after a particular period of time has lapsed (e.g., once a day), or when a user manually prompts user device 402 to update its local information. In some embodiments, local database 404 may update whenever a software program in communication with a database of radio station information or radio presets is launched. For example, local database 404 may update whenever a software program such as iTunes™ (available from Apple, Inc. of Cupertino, Calif.) is launched.

In some embodiments, user device 402 may receive radio station information from Radio Data System (RDS) information 412. RDS information 412 may be, for example, digital information such as station identification, the current song's track, artist, genre, and length information, and/or alternative frequencies for particular stations. Typically, RDS information 412 can be broadcast from radio tower 410 on an AM or FM radio signal.

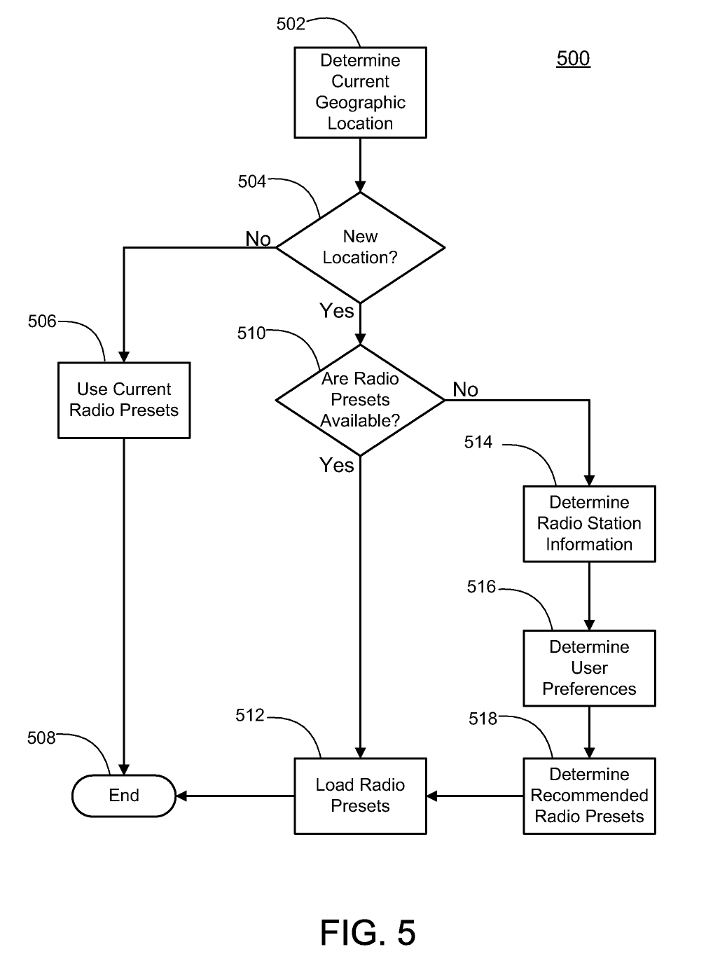

FIG. 5 illustrates process 500 that can be used to customize radio presets. At step 502, the user device can determine the current geographic location of the device. For example, the current geographic location can be determined by any of the above-mentioned ways such as through a GPS system, a cellular network, a location-providing service, a location-providing service, a user-entered location, or determining an area fingerprint.

At step 504, the user device can determine whether the current geographic location is a new location. If the geographic location has not changed, the process can proceed to step 506 and the current radio presets can be retained. Process 500 can then end at step 508.

If, at step 504, the user device instead determines that it is in a new location, process 500 can proceed to step 510. At step 510, the user device can determine whether radio presets are available for the current geographical location. For example, radio presets can be available if a user previously identified radio frequencies and associated those radio frequencies with the current location (e.g., through New Bookmark Option 324 of FIG. 3).

If the user device determines that radio presets are available, process 500 can proceed to step 512. At step 512, the radio presets can be loaded by, for example, populating a set of hot keys with the radio frequencies associated with the current geographic location. After loading radio presets, process 500 can end at step 508.

If, at step 510, the user device instead determines that radio presets are not available, process 500 can proceed to steps 514, 516, and 518 to intelligently determine recommended radio presets. At step 514, the radio station information for the current geographic location can be determined. As described above, the radio station information can be, for example, retrieved from a local database, retrieved from a remote database, or received as RDS information. At step 516, the user device can determine user preferences by any of the above-mentioned ways. For example, a user may provide preferred genres, shows, songs, artists, albums, radio stations, or any combination of the above (e.g., provided through user input mechanisms 108 or 110 of FIG. 1). As another example, the user device can intelligently determine user preferences by monitoring user behavior.

At step 518, recommended radio presets can be determined. In some embodiments, radio station information for the current location can be compared with the user preferences to identify radio stations that match the user preferences. The matching radio stations can be defined as a recommended radio presets. In some embodiments, rather than using user preferences, the recommended radio presets can be determined by comparing the radio station information to radio presets for other locations. In this case, step 516 for determining user preferences can optionally be removed. The recommended radio presets can be loaded at step 512. As mentioned above in reference to step 512, the recommended radio presets can be loaded by, for example, populating a set of hot keys with the radio frequencies associated with the recommended radio presets.

The process discussed above is intended to be illustrative and not limiting. Persons skilled in the art will appreciate that steps of the process discussed herein can be omitted, modified, combined, rearranged, or combinations of these, and any additional steps can be performed without departing from the scope of the invention. For example, rather than loading either available radio presets or recommended radio presets, in some embodiments both may be loaded.

The above described embodiments of the present invention are presented for purposes of illustration and not of limitation, and the present invention is limited only by the claims which follow.

1. A method for customizing radio presets, the method comprising:
determining a current geographical location;
identifying radio preset information associated with the current geographical location, wherein radio preset information is available for a plurality of geographic locations; and
loading the identified radio preset information.

2. The method of claim 1, wherein determining a current geographical location comprises:
defining an area fingerprint based on one or more data points related to received radio station frequencies and their associated signal strengths; and
identifying the current geographical location from a plurality of geographical locations, wherein the current geographical location corresponds to the defined area fingerprint.

3. The method of claim 2, wherein defining an area fingerprint comprises:
performing a background scan to define the area fingerprint.

4. The method of claim 1, wherein determining a current geographical location comprises:
determining the current geographical location from one of a user-entered geographic location, a global positioning system (GPS), a location service provider, and a cellular network system.

5. The method of claim 1, wherein identifying radio preset information comprises:
retrieving the radio preset information associated with the current geographic location from one of a local database and a remote database.

6. The method of claim 1, further comprising:
receiving a selection of a particular radio frequency; and
associating the particular radio frequency with the current geographical location to define a radio preset.

7. The method of claim 1, further comprising:
receiving a selection of a particular radio frequency;
receiving a selection of a particular geographical location; and
associating the particular radio frequency with the particular geographical location to define a radio preset.

8. The method of claim 1, wherein loading the identified radio preset information comprises:
determining that the current geographical location is a new location; and
updating current radio preset information with the identified radio preset information in response to determining the current geographical location is a new location.

9. The method of claim 1, wherein identifying radio preset information comprises:
identifying recommended radio presets based on one or more of radio station information, user preferences, and radio preset information associated with locations that are not the current geographical location.

10. A system for providing geographic-specific radio presets, the system comprising:
a portable device, the portable device comprising:
communications circuitry operative to receive radio preset information for each of a plurality of geographic locations from a host device;
a radio tuner operative to tune a radio frequency; and
a processor operative to:
identify a current geographic location;
select radio preset information associated with the current geographic location and received from the host device; and
direct the radio tuner to tune to a radio frequency associated with the selected radio preset information.

11. The system of claim 10, wherein the processor is further operative to:
determine that the current geographic location is one of the plurality of geographic locations for which radio preset information is stored in memory.

12. The system of claim 10, wherein:
the processor is further operative to define new radio preset information by associating a particular radio frequency with the current geographic location; and
the portable device's communication circuitry is further operative to transmit the new radio preset information to the host device for storing.

13. The system of claim 10, wherein:
the communication circuitry is further operative to:
transmit a selection of a particular radio frequency to the host device; and
transmit a selection of a particular geographical location to the host device to be associated by the host device with the particular radio frequency to define new radio preset information.

14. The system of claim 13, wherein the communication circuitry is further operative to:
receive the new radio present information in response to the host device determining that the particular geographic location corresponds to the current geographic location.

15. A portable electronic device, comprising:
a tuner operative to tune radio frequencies;
positioning circuitry operative to identify a current location of the portable electronic device; and
a processor operative to:
identify a subset of a plurality of radio presets, wherein the subset of radio presets are associated with the current location; and
load the identified subset of radio presets.

16. The portable electronic device of claim 15, wherein the positioning circuitry is further operative to:
identify the current location from one of an area fingerprint, a global positioning system (GPS), a location service provider, a cellular network system, and a user-entered geographic location.

17. The portable electronic device of claim 15, wherein the processor is further operative to:
associate each radio preset of the identified subset of radio presets with a distinct selectable option of the portable device;
receive a selection of a particular selectable option; and
direct the tuner to tune to a radio frequency of the radio preset associated with the particular selectable option.

18. The portable electronic device of claim 15, wherein the processor is further operative to:
identify recommended radio presets for the current location.

19. The portable electronic device of claim 18, wherein the processor is further operative to:
determine that the current location is not associated with any radio presets; and
automatically load the recommended radio presets.

20. Machine-readable media for customizing radio presets, comprising machine-readable instructions recorded thereon for:
determining a current geographical location;
identifying radio preset information associated with the current geographical location, wherein radio preset information is available for a plurality of geographic locations; and
loading the identified radio preset information.

21. A host device comprising:
a storage device operable to store radio preset information for each of a plurality of geographic locations; and
communications circuitry operable to:
receive, from a portable electronic device, a selection of at least one geographic location of the plurality of geographic locations; and
transmit radio preset information associated with the at least one geographic location to the portable electronic device.

22. The host device of claim 21, further comprising a processor operable to:
receive a selection of a particular radio frequency;
receive a selection of a particular geographical location; and
associate the particular radio frequency with the particular geographical location to define new radio preset information, wherein the storage device is further operable to store the new radio preset information.

23. The host device of claim 21, wherein:
the communications circuitry is further operable to receive a current geographic location of the portable electronic device; and
the host device further comprises a processor operable to:
compare the current geographic location to the plurality of geographic locations to determine a matching geographic location; and
direct the communications circuitry to transmit radio preset information associated with the matching geographic location to the portable electronic device.

24. The host device of claim 21, wherein:
the communications circuitry is further operable to receive a current geographic location of the portable electronic device; and
the host device further comprises a processor operable to automatically identify recommended radio preset information to associate with the current geographic location.

25. The host device of claim 24, wherein the processor is further operable to:
determine the current geographic location is not associated with any radio preset information; and
identify the recommended radio preset information to associate with the current geographic location in response to determining the current geographic location is not associated with any radio preset information.

26. The host device of claim 24, wherein the processor is further operable to identify the recommended radio preset information based on one or more of radio station information, user preferences, and radio preset information associated with at least one geographic location that does not match the current geographical location.
